(19) United States
(12) Patent Application Publication
(10) Pub. No.: US 2022/0186645 A1
(43) Pub. Date: Jun. 16, 2022

(54) ENGINE

(71) Applicant: Yanmar Power Technology Co., Ltd., Osaka-shi, Osaka (JP)

(72) Inventors: Yuki SAKAGUCHI, Osaka-shi (JP); Shigeo GODA, Osaka-shi, (JP); Masahiro ITANI, Osaka-shi, (JP)

(73) Assignee: Yanmar Power Technology Co., Ltd., Osaka-shi, Osaka (JP)

(21) Appl. No.: 17/598,463

(22) PCT Filed: Mar. 5, 2020
(86) PCT No.: PCT/JP2020/009340

§ 371 Date: Sep. 27, 2021

(30) Foreign Application Priority Data
Mar. 28, 2019 (JP) 2019-064079

(51) Int. Cl. F01N 3/20; F02D 41/08; F02D 41/06

(52) U.S. Cl. CPC F01N 3/208; F02D 41/08; F02D 41/064; F01N 2610/02; F02D 2200/023; F01N 2900/1404; F02D 2200/0606; F02D 2200/101; F01N 2570/14; F01N 2610/1406; F02D 2200/0414

(57) ABSTRACT

This engine comprises an engine body and an ECU. The ECU is configured to execute a high idling limitation when a prescribed condition is fulfilled during startup. When executing a high idle limitation, the ECU determines a first upper limit speed, which is an upper limit value of high idling speed, and a first limitation time, which is a time during which the high idling limitation continues, on the basis of the engine temperature during startup. Based on the temperature of the environment, the ECU determines a second upper limit speed, which is an upper limit value of high idling speed, and a second limitation time, which is a time during which the high idling limitation continues. The ECU executes the high idling limitation based on either the determined first upper limit speed or second upper limit speed, and either the first limitation time or the second limitation time.

### TECHNICAL FIELD

The present invention relates to a high idle limitation during startup of an engine.

### BACKGROUND ART

Conventionally, a method of limiting high idle rotation has been known to prevent seizure due to insufficient lubrication at high speed rotation during of startup of an engine. Patent Literature 1 discloses a control method for this type of engine during startup.

Patent Literature 1 points out a problem in which, during startup of an engine, temperature of lubricating oil is low and viscosity thereof is high, so that the lubricating oil is not distributed to a rotating unit, and therefore, when an accelerator pedal is stepped to rapidly increase engine rotation, sever wear of the engine rotating unit is caused. In the control method for an engine during startup proposed by Patent Literature 1, when engine cooling water or engine lubricating oil temperature is lower than predetermined temperature, an increase amount of fuel injected from a fuel injection nozzle is limited even when an operation of increasing engine rotation is performed.

### CITATION LIST

### Patent Literature

Patent Literature 1: Japanese Unexamined Patent Application Publication No. 2017-57804

### DISCLOSURE OF INVENTION

### Problems to be Solved by the Invention

However, in a configuration of the above-described Patent Literature 1, a separate temperature sensor that detects engine lubricating oil temperature is required, and cost is increased. In the configuration of Patent Literature 1, an execution time of a high idle limitation is not set. Therefore, if the execution time is short, there is a probability that the engine lubricating oil is not warmed up sufficiently. On the other hand, if the execution time is long, startability of the engine is reduced.

In view of the foregoing, the present invention has been devised, and it is therefore an object of the present invention to provide an engine that can properly execute a high idle limitation while maintaining good startability.

### Means for Solving the Problems

### Effect of the Invention

The problems to be solved by the present invention have been described above, and means for solving the problems and effects thereof will be described below.

According to an aspect of the present invention, an engine having the following configuration is provided. That is, the engine includes an engine body and a control unit that controls the engine body. The control unit is configured to execute a high idle limitation if a prescribed condition is fulfilled during startup. When executing the high idle limitation, the control unit determines first upper limit speed that is an upper limit value of high idling speed, and a first limitation time that is a duration of the high idle limitation, based on engine temperature during startup. The control unit determines second upper limit speed that is the upper limit value of the high idling speed and a second limitation time that is the duration of the high idle limitation, based on environmental temperature. The control unit executes the high idle limitation, based on either the determined first upper limit speed or second upper limit speed and either the first limitation time or the second limitation time.

Thus, high speed rotation when the engine temperature is low can be limited. Therefore, it is possible to prevent seizure from occurring in a turbocharger or the like due to insufficient lubrication.

In the engine, the control unit preferably sets lower speed of the determined first upper limit speed or second upper limit speed as a speed limit value in the high idle limitation.

Thus, the limit speed during the high idle limitation can be set even more appropriately.

In the engine, the control unit preferably sets a longer time of the determined first limitation time and second limitation time as the duration of the high idle limitation.

Thus, the duration of the high idle limitation can be set even more appropriately.

In the engine, the control unit preferably uses lowest temperature among at least cooling water temperature, fuel temperature, and exhaust temperature as the engine temperature.

Thus, the first upper limit speed and the first limitation time can be calculated using a most severe temperature condition of temperatures of various units related to the engine temperature. Accordingly, it is possible to execute a high idle limitation that is more suitable for an operation state of the engine.

The engine preferably has the following configuration. That is, the engine includes an exhaust purification device. The exhaust purification device is configured to mix urea water supplied from a urea water tank with exhaust gas to remove nitrogen oxides contained in the exhaust gas. The control unit uses lowest temperature among fresh air temperature, fuel temperature, and urea water temperature as the environmental temperature.

Thus, the second upper limit speed and the second limitation time that appropriately reflect the operation environment of the engine can be determined by using the most severe condition. Accordingly, high speed rotation at low temperature can be avoided even more reliably.

The engine preferably has the following configuration. That is, the prescribed condition for executing the high idle limitation during startup is that at least cooling water temperature, fuel temperature, and exhaust temperature are all below respective thresholds.

Thus, unnecessary execution of the high idle limitation can be avoided. Therefore, the startability of the engine can be improved.

### BRIEF DESCRIPTION OF DRAWINGS

FIG. 1 is a perspective view illustrating a configuration of an engine according to an embodiment of the present invention.

FIG. 2 is a schematic view illustrating an overall configuration of the engine.

FIG. 3 is a functional block diagram illustrating a configuration of ECU.

FIG. 4 is a block diagram illustrating a high idle limitation during startup.

FIG. 5 is a graph illustrating control for high idle limitation speed when the high idle limitation is released.

### DESCRIPTION OF EMBODIMENTS

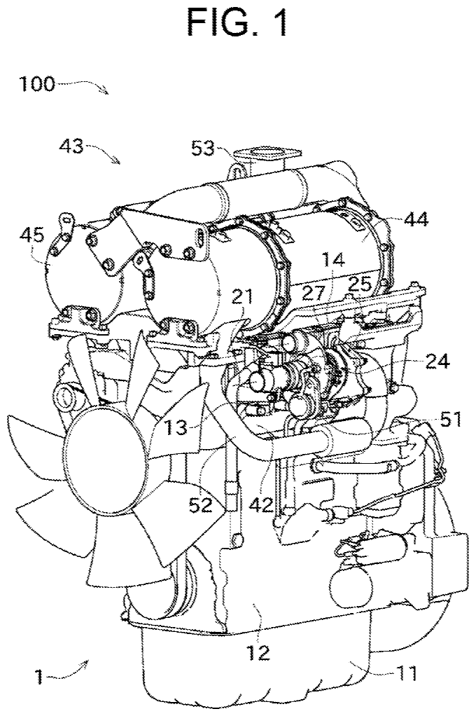

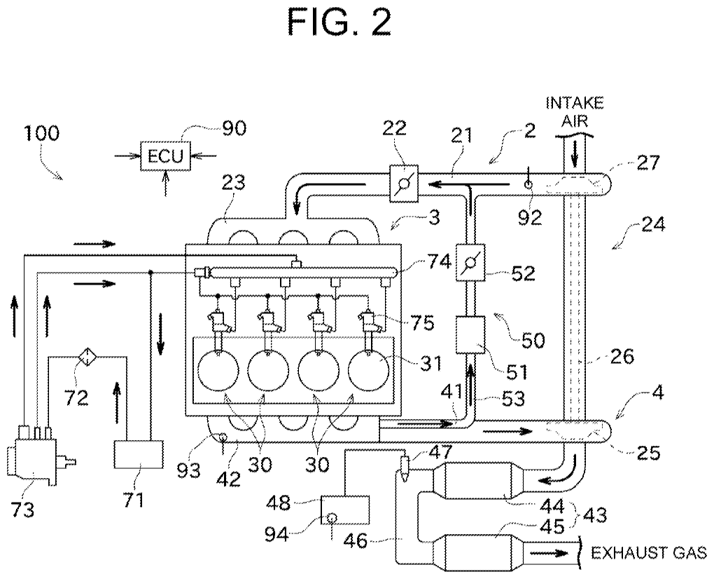

Next, an embodiment of the present invention will be described with reference to the drawings. FIG. 1 is a perspective view illustrating a configuration of an engine 100 according to an embodiment of the present invention. FIG. 2 is a schematic view illustrating an overall configuration of the engine 100.

The engine 100 illustrated in FIG. 1 is a diesel engine and is mounted on, for example, an agricultural machine, such as a tractor, a construction machine, such as an excavator, or the like. The engine 100 is configured as, for example, an in-line four-cylinder engine having four cylinders. Note that the number of cylinders is not limited to four. The engine 100 of this embodiment mainly includes an engine body 1, an exhaust purification device (ATD) 43, and an ECU 90 serving as a control unit. ATD is an abbreviation for after treatment device. ECU is an abbreviation for engine control unit.

First, the basic configuration of the engine body 1 included in the engine 100 will be briefly described. As illustrated in FIG. 1 or the like, the engine body 1 mainly includes an oil pan 11, a cylinder block 12, a cylinder head 13, and a head cover 14 arranged in this order from below.

The oil pan 11 is provided at a lower portion (a lower end portion) of the engine 100. The oil pan 11 is formed in a container shape whose upper portion is open. Engine oil used for lubricating the engine 100 is stored in the oil pan 11.

The engine oil stored in the oil pan 11 is taken in by an unillustrated engine oil pump provided in the engine body 1, and then, is supplied to each unit of the engine body 1, and is returned to and stored in the oil pan 11 after lubricating the engine body 1.

The cylinder block 12 is attached on an upper side of the oil pan 11. The cylinder block 12 has a recess storing an unillustrated crankshaft or the like and a plurality of cylinders 30.

A cylinder head 13 is provided on an upper side of the cylinder block 12. The cylinder head 13 and the cylinder block 12 form the combustion chambers 31 illustrated in FIG. 2 corresponding to the respective cylinders 30.

A piston is housed in each cylinder 30. The piston is coupled to the crankshaft via an unillustrated connecting rod. The crankshaft rotates due to reciprocating motion of the piston.

In the cylinder head 13, an unillustrated water cooling jacket that cools the engine body 1 is formed. The engine 100 of this embodiment is provided with an unillustrated cooling water circulation system to prevent the engine body 1 from becoming overheated due to the combustion of fuel. Note that the water cooling jacket may be formed in the cylinder block instead of the cylinder head 13.

The cooling water circulation system is configured to recirculate the cooling water to the water cooling jacket or the like formed in the cylinder head 13 of the engine body 1, and to exchange heat between the engine body 1 and the water cooling jacket or the like. A cooling water temperature sensor 91 that detects cooling water temperature is provided at an appropriate location in a cooling water path in this cooling water circulation system. The cooling water temperature detected by the cooling water temperature sensor 91 is output to the ECU 90.

The head cover 14 is provided on the upper side of the cylinder head 13. In the head cover 14, a valve mechanism constituted by an unillustrated push rod, rocker arm, or the like and used for operating an unillustrated exhaust valve and a throttle valve 22 that will be described later is housed.

Subsequently, with focus on intake and exhaust flows, a configuration of the engine 100 of this embodiment will be briefly described with reference to FIG. 2 or the like.

As illustrated in FIG. 2, the engine 100 includes an intake unit 2, a power generation unit 3, and an exhaust unit 4 as main components.

The intake unit 2 takes in air from outside. The intake unit 2 includes an intake pipe 21, a throttle valve 22, an intake manifold 23, and a turbocharger 24.

The intake pipe 21 forms an intake passage and can cause the air taken in from the outside to flow therein. A fresh air temperature sensor 92 that detects temperature of air (fresh air) taken in from the outside is provided in a portion of an intake pipe 21 located more upstream than an outlet of an EGR pipe 53 described later. The fresh air temperature detected by the fresh air temperature sensor 92 is output to the ECU 90.

The throttle valve 22 is arranged in a middle portion of the intake passage. The throttle valve 22 changes a cross-sectional area of the intake passage by changing an opening degree thereof in accordance with a control command from the EUC 90. Thus, an amount of air supplied to the intake manifold 23 (that is, an intake air amount) can be adjusted.

The intake manifold 23 is coupled to a downstream side end portion of the intake pipe 21 in a direction in which the intake air flows. The intake manifold 23 distributes the air supplied via the intake pipe 21 in accordance with the number of cylinders 30 and supplies the air to the combustion chambers 31 formed in the respective cylinders 30.

The power generation unit 3 is constituted by a plurality of (four in this embodiment) cylinders 30. The power generation unit 3 generates power to reciprocate the pistons by burning fuel in the combustion chambers 31 formed in the respective cylinders 30.

Specifically, in each combustion chamber 31, the air supplied from the intake manifold 23 is compressed, and then, fuel supplied from a fuel tank 71 is injected. Accordingly, combustion occurs in the combustion chambers 31, so that the pistons can be reciprocated up and down. Power thereby obtained is transmitted to an appropriate device on a power downstream side via the crankshaft or the like.

As illustrated in FIG. 2, the turbocharger 24 includes a turbine 25, a shaft 26, and a compressor 27. The compressor 27 is coupled to the turbine 25 via the shaft 26. As described above, the compressor 27 rotates with rotation of the turbine 25 that rotates by utilizing exhaust gas discharged from the combustion chambers 31, so that air purified by an unillustrated air cleaner is compressed and forcibly taken in. Each portion of the turbocharger 24 is lubricated by engine oil supplied from the oil pan 11.

The exhaust unit 4 discharges exhaust gas generated in the combustion chambers 31 to the outside. The exhaust unit 4 includes an exhaust pipe 41, an exhaust manifold 42, and an ATD 43.

The exhaust pipe 41 forms an exhaust gas passage and the exhaust gas discharged from the combustion chambers 31 can flow therein.

The exhaust manifold 42 is coupled to an upstream side end of the exhaust pipe 41 in a direction in which the exhaust gas flows. The exhaust manifold 42 collectively guides the exhaust gas generated in each of the combustion chambers 31 to the exhaust pipe 41.

An exhaust temperature sensor 93 that detects exhaust temperature is provided in the exhaust manifold 42. The exhaust temperature detected by the exhaust temperature sensor 93 is output to the ECU 90. Note that the exhaust temperature sensor 93 may be provided in some other location in the exhaust gas passage formed of the exhaust pipe 41.

The engine body 1 is provided with an EGR device 50 that recirculates a portion of exhaust gas to an intake side. The EGR device 50 includes an EGR cooler 51, an EGR valve 52, and an EGR pipe 53.

The EGR pipe 53 is a path used for guiding EGR gas that is exhaust gas to be recirculated to the intake side to the intake pipe 21, and is provided to communicate the exhaust pipe 41 (or the exhaust manifold 42) and the intake pipe 21.

The EGR cooler 51 is provided in a middle portion of the EGR pipe 53 and cools the EGR gas recirculated to the intake side.

The EGR valve 52 is provided in a position in the middle portion of the EGR pipe 53 and a downstream side of the EGR cooler 51 in a recirculation direction of the EGR and is configured to adjust a recirculation amount of the EGR gas.

The ATD 43 is a device that performs exhaust gas aftertreatment. The ATD 43 purifies the exhaust gas by removing harmful components, such as NOx (nitrogen oxides), CO (carbon monoxide), HC (hydrocarbons), or the like, and a particulate matter (PM) contained in the exhaust gas. The ATD 43 is arranged in a middle portion of the exhaust pipe 41. The ATD 43 may be arranged above the engine body 1 or may be arranged separately from the engine body 1.

The ATD 43 includes a DPF device 44 and an SCR device 45. DPF is an abbreviation for diesel particulate filter. SCR is an abbreviation for selective catalytic reduction.

The DPF device 44 removes carbon monoxide, nitric oxide, a particulate matter, or the like contained in the exhaust gas via unillustrated oxidation catalyst and filter. The oxidation catalyst is a catalyst constituted by platinum or the like and is used for oxidizing (burning) unburned fuel, carbon monoxide, nitric oxide, or the like contained in the exhaust gas. The filter is arranged on a more downstream side of the exhaust gas than the oxidation catalyst and is configured as, for example, a fall flow type filter. The filter collects the particulate matter contained in the exhaust gas treated with the oxidation catalyst.

The exhaust gas that has passed through the DPF device 44 is sent to the SCR device 45 via a urea mixing tube 46 that connects an outlet pipe of the DPF device 44 and an inlet pipe of the SCR device 45.

A urea water injection section 47 is attached near an upstream side end of the urea mixing tube 46. The urea water injection section 47 injects urea water supplied from a urea water tank 48 into the urea mixing tube 46. Thus, in the urea mixing tube 46, the exhaust gas is mixed with the urea water and is guided to the SCR system 45.

The urea water tank 48 is provided separately from the engine body 1. The urea water tank 48 is provided with a urea water temperature sensor 94 that detects urea water temperature. The urea water temperature detected by the urea water temperature sensor 94 is output to the ECU 90. Note that, instead of the urea water temperature sensor 94, a urea water tank temperature sensor may be provided to indirectly detect the urea water temperature.

The SCR device 45 removes NOx contained in the exhaust gas via an SCR catalyst and a slip catalyst. The SCR catalyst is made of a material, such as ceramic or the like, that adsorbs ammonia. NOx contained in the exhaust gas is reduced by contact with the SCR catalyst that has adsorbed ammonia and is changed into nitrogen and water. The slip catalyst is used to prevent ammonia from being released to the outside. The slip catalyst is a catalyst, such as platinum or the like, that oxidizes ammonia, and oxidizes ammonia to change ammonia into nitrogen and water.

The exhaust gas that has passed through the SCR device 45 is discharged to the outside via the exhaust pipe coupled to an exhaust gas outlet of the SCR device 45.

Next, a configuration supplying and injecting fuel in the engine 100 of this embodiment will be briefly described.

As illustrated in FIG. 2, the engine 100 includes a fuel filter 72, a fuel pump 73, a common rail 74, and an injector 75.

The engine 100 takes in fuel from the fuel tank 71 that stores fuel via the fuel pump 73. The fuel tank 71 is provided separately from the engine body 1.

The fuel taken in by the fuel pump 73 passes through the fuel filter 72, so that dust and dirt contained in the fuel are thereby removed. Thereafter, the fuel is supplied to the common rail 74. The common rail 74 stores fuel at high pressure and distributes the fuel to the plurality of injectors 75 (four in this embodiment).

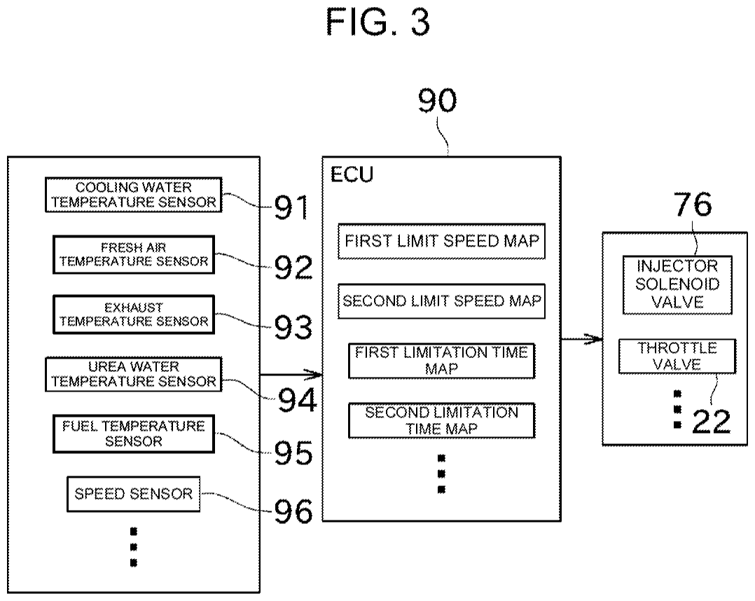

The injectors 75 inject fuel into the combustion chambers 31. Each of the injectors 75 includes an injector solenoid valve 76 illustrated in FIG. 3. The ECU 90 is electrically coupled to the injector solenoid valve 76. The injector solenoid valve 76 opens and closes at a timing corresponding to a signal from the ECU 90. Accordingly, the injectors 75 inject fuel into the combustion chambers 31.

A fuel temperature sensor 95 that detects fuel temperature is provided at an appropriate location in a fuel path from the fuel tank 71 to the injectors 75. The fuel temperature detected by the fuel temperature sensor 95 is output to the ECU 90. Speaking from a viewpoint of excellently reflecting temperature of an environment in which the engine 100 operates to the fuel temperature, it is preferable to provide the fuel temperature sensor 95 in the fuel tank 71.

The ECU 90 is constituted by a CPU that executes various arithmetic processes and controls and a ROM and RAM as storage units, and is arranged in or near the engine body 1.

Various programs and a plurality of control information (for example, a control map, temperature thresholds) preset with respect to control of the engine body 1 are stored in the ECU 90. Examples of the control map stored in the ECU 90 include, for example, a map indicating an upper limit of speed corresponding to temperature of each unit and a duration of a high idle limitation or the like. Examples of the temperature thresholds stored in the ECU 90 include, for example, cooling water lower limit temperature, fuel lower limit temperature, and exhaust lower limit temperature that are used to determine whether to execute a high idle limitation.

With reference to FIG. 3, the ECU 90 will be described in detail. FIG. 3 is a functional block diagram illustrating a configuration of the ECU 90.

The ECU 90 can obtain information of urea water temperature, speed of the engine body 1, intake air temperature (fresh air temperature), fuel temperature, cooling water temperature, exhaust temperature, or the like, based on detection results output from various sensors, as illustrated in FIG. 3. The ECU 90 then controls an operation of the engine body 1, based on the above-described information reflecting a state of the engine body 1 obtained from various sensors.

Examples of the various sensors described above include the cooling water temperature sensor 91, the fresh air temperature sensor 92, the exhaust temperature sensor 93, the urea water temperature sensor 94, and the fuel temperature sensor 95 described above. In addition to the above-described sensors, for example, a speed sensor 96 or the like can be used.

The speed sensor 96 is configured, for example, as the crank sensor that detects rotation of the crankshaft and detects the speed of the engine 100. The speed detected by the speed sensor 96 is output to the ECU 90.

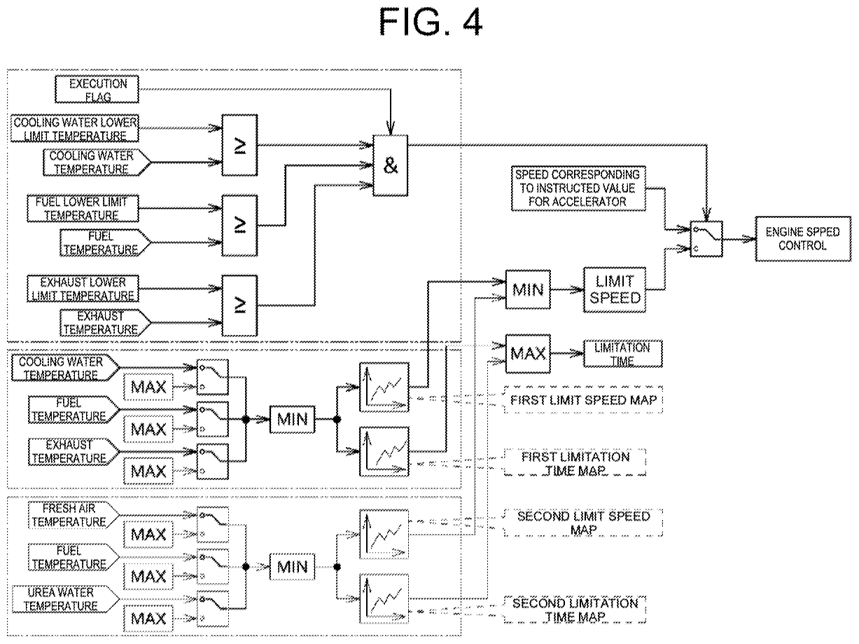

Next, with reference to FIG. 4, a high idle limitation that is control by the ECU 90 on the speed of the engine 100 during startup will be described. FIG. 4 is a block diagram illustrating a high idle limitation during startup.

In the engine 100 of this embodiment, the ECU 90 executes a high idle limitation on the engine 100 if the prescribed condition is fulfilled during startup of the engine 100. The high idle limitation is control that prevents the speed of the engine 100 from exceeding a set limit speed. While the high idle limitation is being executed, even when an accelerator pedal is stepped, the speed of the engine 100 will not rise above a set limit speed once the speed has reached the limit speed.

This high idle limitation is performed to avoid high speed rotation and to protect each unit of the engine body 1 (for example, the turbocharger 24 or the like), especially when temperature in an operation environment of the engine 100 is very low and an operation state of the engine 100 during startup is not suitable for the high speed rotation.

Specific examples of an operation state unsuitable for high speed rotation are as follows. That is, when engine temperature that is temperature of the engine body 1 has not risen sufficiently during startup, the engine oil is not warmed up sufficiently and flowability is poor. Therefore, the engine oil does not immediately spread sufficiently to each unit of the engine body 1. As a result, each unit of the engine body 1 is not sufficiently lubricated, and seizure or the like is likely to occur at high speed rotation.

In the engine 100 of this embodiment, as illustrated in FIG. 4, the ECU 90 obtains the cooling water temperature, the fuel temperature, and the exhaust temperature from the cooling water temperature sensor 91, the fuel temperature sensor 95, and the exhaust temperature sensor 93, respectively, after the engine 100 is started, and determines whether to execute a high idle limitation, based on the obtained cooling water temperature, fuel temperature, and exhaust temperature.

Specifically, the ECU 90 compares the obtained cooling water temperature, fuel temperature, and exhaust temperature with cooling water lower limit temperature, fuel lower limit temperature, and exhaust lower limit temperature that are respective thresholds. If any of the cooling water temperature, the fuel temperature, and the exhaust temperature is the corresponding threshold or more, the ECU 90 causes the engine 100 to operate normally. That is, a driver causes the speed of the engine 100 at which a high idle limitation is not executed to follow an instructed value for an accelerator, which is the speed corresponding to an accelerator opening at which the engine 100 is operated. Thus, execution of a high idle limitation in a case where the operation state of the engine 100 is normal can be avoided, so that startability of the engine 100 can be well maintained.

On the other hand, if the cooling water temperature is below the cooling water lower limit temperature, the fuel temperature is below the fuel lower limit temperature, and the exhaust temperature is below the exhaust lower limit temperature, the ECU 90 executes a high idle limitation. That is, the ECU 90 controls the speed of the engine 100 such that the speed of the engine 100 does not exceed the set limit speed by controlling, for example, the fuel injection amount, the intake air amount, or the like.

Note that this high idle limitation may be set not to be executed by a special operation of a service person or the like. For example, as illustrated in FIG. 4, an execution flag (for example, 0/1) that is set by a special operation is used as a condition in the above-described execution determination of the high idle limitation.

That is, when the execution flag is set to “1” by an operation of the driver or the like, the above-described execution determination becomes effective, and when the above-described prescribed condition (that is, when the cooling water temperature, the fuel temperature, and the exhaust temperature are all below the corresponding thresholds thereof) is fulfilled, the high idle limitation is executed.

On the other hand, if the execution flag is set to “0” by the operation of the driver or the like, the above-described execution determination is invalidated and high idle limitation is not forcedly executed even when the above-described prescribed condition is fulfilled.

When it is determined that the above prescribed condition is fulfilled and the high idle limitation is executed, the ECU 90 determines each of a first upper limit speed, a first limitation time, a second upper limit speed, and a second limitation time.

Each of the first upper limit speed and the second upper limit speed is limit speed used in the high idle limitation. Each of the first limitation time and the second limitation time is a duration of the high idle limitation.

The first upper limit speed and the first limitation time are determined in accordance with a current operation state of the engine 100 (and hence the engine temperature that is the temperature of the engine body 1). The second upper limit speed and the second limitation time are determined in accordance with environmental temperature in the operation environment of the engine 100.

In a case of determining the first upper limit speed and the first limitation time, the ECU 90 uses lowest temperature among the cooling water temperature, the fuel temperature, and the exhaust temperature that can reflect a temperature state of the engine body 1 as the engine temperature. Thus, the first upper limit speed and first limitation time can be determined using a most severe temperature condition, and therefore, the engine body 1 can be protected even more reliably.

The ECU 90 can set such that at least any of the cooling water temperature, the fuel temperature, and the exhaust temperature is not used in determining the first upper limit speed and the first limitation time. This configuration is illustrated by a changeover switch in FIG. 4. For temperature that has been set not to be used for calculation, as illustrated in FIG. 4, an upper limit value of a range of the temperature is output as dummy temperature. Since a minimum value of temperature is used as described above, this dummy temperature is not substantially used for calculation.

Based on the engine temperature obtained in the manner described above, the ECU 90 determines the first upper limit speed and the first limitation time using a first limit speed map and a first limitation time map stored in advance. The first limit speed map and the first limitation time map can be represented, for example, as a two-dimensional table in which the limit speed or the limitation time are associated with the engine temperature.

The ECU 90 uses the fresh air temperature, the fuel temperature, and the urea water temperature as the temperature (environmental temperature) of the operation environment that is an external environment in which the engine 100 operates.

Since the fresh air is air newly taken in from outside via the turbocharger 24, the fresh air temperature reflects temperature of outside air at least to some extent.

And since the fuel tank 71 and the urea water tank 48 are arranged away from the engine body 1 as described above, they are less affected by heat generation during operation of the engine 100. Accordingly, the fuel temperature and the urea water temperature detected in the fuel tank 71 and the urea water tank 48 reflect the temperature of the external environment of the engine 100 at least to some extent.

The ECU 90 uses, as the environmental temperature, lowest temperature among the fresh air temperature, the fuel temperature, and the urea water temperature that can reflect the environmental temperature of the external environment in which the engine 100 operates. Thus, the second upper limit speed and the second limitation time can be determined using a most severe environmental temperature condition, and therefore, each unit of the engine body 1 can be protected even more reliably.

The ECU 90 can set such that at least any of the fresh air temperature, the fuel temperature, and the urea water temperature is not used in determining the second upper limit speed and the second limitation time. This configuration is illustrated by a changeover switch in FIG. 4. For temperature that has been set not to be used for calculation, as illustrated in FIG. 4, an upper limit value of a range of the temperature is output as dummy temperature. Since a minimum value of temperature is used as described above, this dummy temperature is not substantially used for calculation.

Based on the engine temperature obtained in the manner described above, the ECU 90 determines the second upper limit speed and the second limitation time using a second limit speed map and a second limitation time map stored in advance. The second limit speed map and the second limitation time map can be represented, for example, as a two-dimensional table in which the limit speed and the limitation time are associated with the environmental temperature.

After determining the first upper limit speed and the first limitation time, and the second upper limit speed and the second limitation time in the manner described above, the ECU 90 sets, as the limit speed in the high idle limitation, a smaller value (that is, lower speed) of the determined first upper limit speed and second upper limit speed, and controls rotation of the engine body 1.

The ECU 90 sets a higher value (longer time) of the determined first limitation time and second limitation time as a duration (execution time) of the high idle limitation.

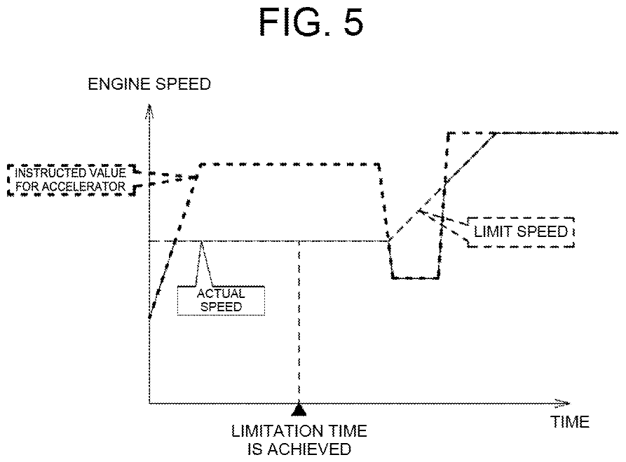

After the duration of the high idle limitation has been achieved, the high idle limitation may be automatically released, and may be released by an accelerator instruction of the driver, as illustrated in FIG. 5.

In a case where the high idle limitation is released by the accelerator instruction of the driver, for example, as illustrated in FIG. 5, the ECU 90 compares, after the duration of the high idle limitation has ended, an instructed value for an accelerator, which is engine speed corresponding to an accelerator opening obtained from an unillustrated accelerator opening detection unit, with the limit speed of the high idle limitation. If the ECU 90 determines that the instructed value for the accelerator is the limit speed or less, the ECU 90 sets the limit speed such that the limit speed gradually increases within a predetermined time. After the predetermined time has elapsed, the limit speed is caused to follow the instructed value for accelerator.

As described above, the engine 100 of this embodiment includes the engine body 1 and the ECU 90. The ECU 90 controls the engine body 1. The ECU 90 is configured to execute a high idle limitation when a prescribed condition is fulfilled during startup. When executing the high idle limitation, the ECU 90 determines the first upper limit speed that is an upper limit value of high idling speed and the first limitation time that is a duration of the high idle limitation, based on the engine temperature during startup. Based on the environmental temperature, the ECU 90 determines the second upper limit speed that is the upper limit of the high idling speed and the second limitation time that is the duration of the high idle limitation. The ECU 90 executes the high idle limitation, based on either the determined first upper limit speed or second upper limit speed and either the first limitation time or the second limitation time.

Thus, high speed rotation when the engine temperature is low can be limited. Therefore, it is possible to prevent seizure from occurring in a turbocharger or the like due to insufficient lubrication.

In the engine 100 of this embodiment, the ECU 90 sets lower speed of the determined first upper limit speed and the second upper limit speed as a speed limit value in the high idle limitation.

Thus, the limit speed during the high idle limitation can be set even more appropriately.

In the engine 100 of this embodiment, the ECU 90 sets a longer time of the calculated first limitation time and second limitation time as the duration of the high idle limitation.

Thus, the duration of the high idle limitation can be set even more appropriately.

In the engine 100 of this embodiment, the ECU 90 uses, as the engine temperature, lowest temperature among at least the cooling water temperature, the fuel temperature, and the exhaust temperature.

Thus, the first upper limit speed and the first limitation time can be calculated using the most severe temperature condition of temperatures of the various units related to the engine temperature. Accordingly, it is possible to execute the high idle limitation that is more suitable for the operation state of the engine.

The engine 100 of this embodiment includes the ATD 43. The ATD 43 is configured to mix urea water supplied from the urea water tank 48 with exhaust gas to remove nitrogen oxides contained in the exhaust gas. The ECU 90 uses the lowest temperature among the fresh air temperature, the fuel temperature, and the urea water temperature as the above-described environmental temperature.

Thus, the second upper limit speed and the second limitation time that appropriately reflect the operation environment of the engine 100 can be determined by using the most severe condition. Accordingly, high speed rotation at low temperature can be avoided even more reliably.

In the engine 100 of this embodiment, the prescribed condition under which the high idle limitation is executed during startup is that at least the cooling water temperature, the fuel temperature, and the exhaust temperature are all below the respective thresholds thereof.

Thus, unnecessary execution of the high idle limitation can be avoided and the startability of the engine 100 can be increased.

Although a preferred embodiment of the present invention has been described above, the above-described configuration can be modified as follows, for example.

The engine 100 may not include the EGR device 50. In this case, the cooling water temperature sensor 91 may be arranged at any location in the intake passage constituted by the intake pipe 21 and may be arranged in the intake manifold 23.

The exhaust temperature sensor 93 may not be provided. In this case, for example, EGR gas temperature detected by an unillustrated EGR gas temperature sensor provided in the EGR device 50 can be used as the exhaust temperature.

The fuel temperature used in determining the first upper limit speed and the fuel temperature used in determining the second upper limit speed may be detected from different temperature sensors. For example, the fuel temperature used in determining the first upper limit speed is detected by a fuel temperature sensor provided in a position close to the injectors 75, and the fuel temperature used in determining the second upper limit speed is detected by a fuel temperature sensor located in the fuel tank 71.

The temperature of the engine oil can be used as the engine temperature. In this configuration, lowest temperature among the cooling water temperature, the fuel temperature, the exhaust temperature, and the engine oil temperature is used as the engine temperature.

### DESCRIPTION OF REFERENCE NUMERALS

1 Engine body
90 ECU (control unit)
100 Engine

1. An engine comprising:
an engine main body; and
a control unit configured to control the engine main body,
wherein the control unit is configured to execute a high idle limitation if a prescribed condition is fulfilled during startup,
when the high idle limitation is executed, the control unit is configured to:
determine a first upper limit speed that is an upper limit value of high idling speed and a first limitation time that is a duration of the high idle limitation, based on engine temperature during startup,
determine a second upper limit speed that is the upper limit value of the high idling speed and a second limitation time that is the duration of the high idle limitation, based on environmental temperature, and
execute the high idle limitation, based on either the determined first upper limit speed or second upper limit speed and either the first limitation time or the second limitation time.

2. The engine according to claim 1, wherein the control unit is configured to set a lower speed of the determined first upper limit speed and the determined second upper limit speed as a speed limit value in the high idle limitation.

3. The engine according to claim 1, wherein the control unit is configured to set a longer time of the determined first limitation time and the determined second limitation time as the duration of the high idle limitation.

4. The engine according to claim 1, wherein the control unit is configured to use a lowest temperature among a cooling water temperature, a fuel temperature, and an exhaust temperature as the engine temperature.

5. The engine according to claim 1, comprising:
an exhaust purification device configured to mix urea water supplied from a urea water tank with exhaust gas to remove nitrogen oxides contained in the exhaust gas, and
wherein the control unit is configured to use a lowest temperature among a fresh air temperature, a fuel temperature, and a urea water temperature as the environmental temperature.

6. The engine according to claim 1, wherein the prescribed condition for executing the high idle limitation during startup is that a cooling water temperature, a fuel temperature, and an exhaust temperature are all below respective thresholds.
